(19) United States
(12) Patent Application Publication
(10) Pub. No.: US 2018/0090020 A1
(43) Pub. Date: Mar. 29, 2018

(54) SYSTEM FOR THE TREATMENT OF VESTIBULAR DYSFUNCTION

(71) Applicants: Howard T. Mango, Newport Beach, CA (US); Brooke Pearce, Huntington Beach, CA (US); Jennifer Grace, Fullerton, CA (US); Mark Cuban, Dallas, TX (US)

(72) Inventors: Howard T. Mango, Newport Beach, CA (US); Brooke Pearce, Huntington Beach, CA (US); Jennifer Grace, Fullerton, CA (US); Mark Cuban, Dallas, TX (US)

(21) Appl. No.: 15/716,359

(22) Filed: Sep. 26, 2017

Related U.S. Application Data
(60) Provisional application No. 62/399,972, filed on Sep. 26, 2016.

(51) Int. Cl. G09B 5/02; G09B 19/00

(52) U.S. Cl. CPC G09B 5/02; G09B 19/00

(57) ABSTRACT

A method for the treatment of vestibular dysfunction that includes providing a virtual reality device to a patient, playing a first phase one stimulation video on the virtual reality device that includes a first amount of phase one three-dimensional objects, playing a first phase one suppression video. The first phase one suppression video includes an amount of phase one three-dimensional objects that is less than the first amount of phase one three-dimensional objects. Playing a first phase two stimulation video that includes a first amount of phase two three-dimensional objects. Playing a first phase two suppression video that includes an amount of phase two three-dimensional objects that is less than the first amount of phase two three-dimensional objects. Playing a first phase three stimulation video that includes a first amount of phase three three-dimensional objects, and playing a first phase three suppression video that includes an amount of phase three three-dimensional objects that is less than the first amount of phase three three-dimensional objects.

### CROSS REFERENCE TO RELATED APPLICATIONS

This application claims the benefit of U.S. Provisional Application No. 62/399,972, filed Sep. 26, 2016, the entirety of which is incorporated by reference herein.

### FIELD OF THE INVENTION

The present invention relates to a system for the treatment of vestibular dysfunction, and, more particularly to a system for the treatment of vestibular dysfunction using 3D, virtual reality goggles or the like.

### BACKGROUND OF THE INVENTION

Many people suffer from vestibular dysfunction, which causes dizziness, vertigo and balance disorders. It will be appreciated by those of ordinary skill in the art that the present invention treats and rehabilitates patients who have functional (not structural) anomalies of the vestibular system. Known as peripheral vestibulopathy, it manifests as vestibular system dysfunction in one ear or the other, or both. Peripheral vestibulopathy causes dizziness, vertigo or imbalance because the vestibular system does not functionally send equal or balanced signals to the brain. U.S. Pat. No. 7,892,180 is incorporated by reference herein in its entirety.

### SUMMARY OF THE PREFERRED EMBODIMENTS

In accordance with a first aspect of the present invention there is provided a method for the treatment of vestibular dysfunction that includes (a) providing a virtual reality device to be worn by a patient, and (b) beginning phase one of treatment. Step (c) includes playing a first phase one stimulation video on the virtual reality device that is configured to stimulate the patient's vestibular ocular reflex. The first phase one stimulation video includes a first amount of phase one three-dimensional objects. Step (d) includes playing a first phase one suppression video on the virtual reality device that is configured to suppress the patient's vestibular ocular reflex. The first phase one suppression video includes an amount of phase one three-dimensional objects that is less than the first amount of phase one three-dimensional objects. Steps (c) and (d) are performed while the patient is in a static state. Step (e) includes comparing the patient's vestibular ocular reflex to a range of vestibular ocular reflex normative data. When the patient's vestibular ocular reflex is within the range of vestibular ocular reflex normative data the patient moves to phase two. If the patient's vestibular ocular reflex is not within the range of vestibular ocular reflex normative data the patient continues treatment in phase one. This typically includes viewing second or more phase one stimulation and suppression videos that include stimuli as described herein. Once again, when the patient's vestibular ocular reflex is within the range of vestibular ocular reflex normative data the patient moves to phase two. Step (f) includes beginning phase two of treatment. Step (g) includes playing a first phase two stimulation video on the virtual reality device that is configured to stimulate the patient's vestibulospinal reflex and integrate the vestibulospinal reflex and vestibular ocular reflex functions. The first phase two stimulation video includes a first amount of phase two three-dimensional objects. Step (h) includes playing a first phase two suppression video on the virtual reality device that is configured to suppress the patient's vestibulospinal reflex and integrate the vestibulospinal reflex and vestibular ocular reflex functions. The first phase two suppression video includes an amount of phase two three-dimensional objects that is less than the first amount of phase two three-dimensional objects. Steps (g) and (h) are performed while the patient is in a dynamic state. Step (i) includes comparing the patient's vestibulospinal reflex to a range of vestibulospinal reflex normative data. When the patient's vestibulospinal reflex is within the range of vestibulospinal reflex normative data the patient moves to phase three. If the patient's vestibulospinal reflex is not within the range of vestibulospinal reflex normative data the patient continues treatment in phase two. This typically includes viewing second or more phase two stimulation and suppression videos that include stimuli as described herein. Once again, when the patient's vestibulospinal reflex is within the range of vestibulospinal reflex normative data the patient moves to phase three. Step (j) includes beginning phase three of treatment. Step (k) includes playing a first phase three stimulation video on the virtual reality device that is configured to stimulate the patient's otolith dysfunction. The first phase three stimulation video includes a first amount of phase three three-dimensional objects. Step (l) includes playing a first phase three suppression video on the virtual reality device that is configured to suppress the patient's otolith dysfunction. The first phase three suppression video includes an amount of phase three three-dimensional objects that is less than the first amount of phase three three-dimensional objects. Steps (k) and (l) are performed while the patient is in a super dynamic state. The method also includes comparing the patient's otolith dysfunction to a range of otolith function normative data. When the patient's otolith dysfunction is within the range of otolith function normative data the patient finishes the treatment process. If the patient's otolith dysfunction is not within the range of otolith function normative data the patient continues treatment in phase three.

The present invention relates to the application of full, 3-D virtual reality stimuli (e.g., Oculus Rift goggles, PC computer and optokinetic (OPK) stimulation (in clinic), Oculus Gear VR goggles, Samsung phone and optokinetic (OPK) stimulation (at home/remote)) to provide in office (e.g., a doctor's office) and/or remote (e.g., at a patient's home) therapy and treatment of vestibular dysfunction that causes dizziness, vertigo and balance disorders. It will be appreciated by those of ordinary skill in the art that virtual reality is the computer-generated simulation of a three-dimensional image or environment that can be interacted with in a seemingly real or physical way by a person using special electronic equipment, such as a helmet or goggles with a screen inside. The present invention can also be implemented in augmented reality. As used herein “virtual reality” covers both virtual reality and augmented reality. Exemplary virtual reality devices are taught in U.S. Pat. Nos. 9,063,330 and 9,749,451 and U.S. Patent Pub Nos. 2016/0357261, 2017/0061696 and 2016/0335801 the entireties of which are incorporated herein by reference.

In use, a practitioner evaluates patients with dizziness, vertigo and balance disorders through a comprehensive vestibular system test battery to assess all 10 end organs of the inner ear (five in the left ear and five in the right ear), which are responsible for two main reflexes in the balance system: the vestibular ocular reflex (VOR) and the vestibulospinal reflex (VSR). Patients with specific vestibular dysfunction (vestibulopathy) will have significant VOR, VSR, otolith dysfunction, or a combination thereof

In a preferred embodiment, the system includes three phases: Phase one is VOR therapy, phase two is VSR therapy, and phase three is otolith therapy. Once the patient's vestibular dysfunction is identified and isolated through comprehensive static and dynamic diagnostic testing, a patient-specific, customized therapy protocol is developed and applied both in house (e.g., at a clinic or doctor's office) and remotely (e.g., at a patient's home or other location remote from the clinic or doctor's office) through a virtual reality device to re-habituate the patient's balance response and return the patient to a normative functional state.

Specifically, application of the virtual reality device assists in promoting the natural progression of central compensation for the vestibulopathy (ear and eyes to the brain and back to the eyes) by retraining the patient's system in a way that allows for habituation, substitution and adaptation to take place.

The invention provides a means to deliver a controlled, consistent and progressive stimuli in a repetitive way over a period of time based on regularly reassessed hyper-stimulation thresholds. The goggles or virtual reality device are the delivery point of the stimuli to help retrain the system, beginning with simple and fundamental 3-dimensional stimuli progressing in a tiered approach to full, 3-dimensional virtual reality stimuli that emulate dynamic real-world environments.

As the brain habituates to, and balance compensation progresses from, presented stimuli in each tier of therapy, the patient's hyper-stimulation threshold is reassessed and more complex stimuli (e.g., increased speed and/or density and/or direction) are introduced into therapy. These tiers of stimuli and reassessment are the building blocks used to progress patients through therapy. During each phase, measurements are taken at key points that allow the provider to assess the patient's current level of central compensation compared to normative data as well as compared to the patient's previous levels of data offset. These assessments also allow the provider or treating clinician to redirect and fine tune the patient's therapy more directly given the understanding of where their system is at that time compared to the normative data.

To drive patient-specific therapy and treatment of vestibular dysfunction, OPK stimulation (in the form of 3-dimensional virtual reality stimuli) is loaded onto, managed through and updated on the virtual reality device (e.g., Oculus Rift goggles/PC and Oculus Gear VR goggles/Samsung phone). Use of the virtual reality device, which completely covers the patient's eyes, has been found to be particularly effective, because it eliminates any secondary, peripheral visual stimulation and immerses the patient in the primary therapeutic visual stimulation where both speed and density of the therapeutic stimuli can be adjusted. Additionally, therapeutic efficacy is enhanced because patient balance compensation and habituation is regularly reassessed by a practitioner and new stimuli is prescribed to dynamically rehabilitate the patient to a normative state.

The first phase (phase one) of treatment hyper-stimulates the vestibular system in order to rehabilitate the VOR. In a preferred embodiment, phase one of therapy is done while the patient is seated, wearing the virtual reality device and watching/interacting with the OPK virtual reality stimuli. Phase one is done to habituate and strengthen the VOR.

Patient-specific hyper-stimulation therapy thresholds are obtained from regular diagnostic testing. In a preferred embodiment of the invention, treatment begins with slow optokinetic speeds (e.g. 20 degrees per second) with horizontal, vertical and/or diagonal stimuli presentation. For example, patient-specific stimuli are uploaded to the virtual reality device according to the aforementioned hyper-stimulation thresholds of the patient, then continually reassessed and adjusted to match more complex patient habituation.

Stimulation and suppression is always presented to each patient. Using OPK stimuli videos delivered through the virtual reality device, the patient's brain is hyper-stimulated then suppressed, as this is what the patient with vestibular dysfunction cannot achieve on their own in a controlled manner.

Once the objective clinical data and the patient's reported subjective data improve in regards to VOR function, the VSR is strengthened during phase two of treatment. Now standing on a static surface 22 (e.g., a concrete or wooden floor) and/or dynamic surface, (e.g., a foam pad), the patient is treated in clinic or at home wearing the virtual reality device and viewing patient-specific OPK stimuli in order to integrate the VSR and VOR functions. As in phase one of treatment, the clinician monitors the patient's compensation progress, updates the prescription of treatment stimuli, accordingly, and uploads or otherwise delivers the new stimuli videos to the patient's virtual reality device. It will be appreciated that the programs uploaded to and/or viewed by the patient on the virtual reality device (e.g., goggles) are referred to herein as videos. However, this is not intended to be limiting. Any program viewed on the virtual reality device and includes three-dimensional images is within the scope of the present invention.

After the VSR compensation is achieved, phase three of treatment is addressed. Any uncompensated otolith dysfunction is subsequently treated while the patient is in a dynamic or super dynamic state (e.g., seated on an exercise ball, bouncing on a trampoline 36, sitting in a rotational chair) while wearing the virtual reality device and accessing patient-specific treatment stimuli videos. As in phases one and two of treatment, the treating doctor of audiology monitors the patient's compensation progress, reassesses hyper-stimulation threshold and updates the prescription of treatment stimuli, then uploads the new stimuli videos to the patient's virtual reality device.

In the exemplary embodiment, the patient is seen twice weekly in the clinic where real-time compensation states are obtained. In between patient visits to the clinic or doctor's office, the patient performs their own home-therapy sessions using the virtual reality device. Other embodiments include, all home-based therapy sessions or the patient seen once per week or more than twice per week. As objective improvement is obtained in the clinic and compared to normative data, the patient is progressed to the increased OPK stimulation in speed and/or density and/or direction. In other words, as the patient's balance compensation and habituation occurs through brain plasticity, the clinician prescribes updated OPK stimulation videos that are uploaded to the virtual reality device.

At the completion of treatment, the patient's objective data is compared to the normative data and the patient completes a subjective questionnaire (dizziness handicap index (DHI)) with regards to their overall balance functionality. It will be appreciated by those of ordinary skill in the art that the patient graduates from treatment after the three phases of treatment have been completed, which, in an exemplary embodiment, include six consecutive weeks of twelve clinical sessions and concurrent home-based virtual reality therapy. Exemplary videos can include horizontal optokinetic videos: slow speed right, medium speed right, fast speed right, slow speed left, medium speed left, fast speed left; vertical optokinetic videos: slow speed up, medium speed up, fast speed up, slow speed down, medium speed down, fast speed down; diagonal optokinetic videos: slow speed down left, medium speed down left, fast speed down left, slow speed down right, medium speed down right, fast speed down right, slow speed up left, medium speed up left, fast speed up left, slow speed up right, medium speed up right, fast speed up right; alternating optokinetic videos: horizontal slow speed left & right, horizontal medium speed left & right, horizontal fast speed left & right; vertical slow speed up & down, vertical medium speed up & down, vertical fast speed up & down; saccades optokinetic videos: horizontal random spacing & timing, horizontal random spacing, omnidirectional random spacing & timing, omnidirectional random spacing, vertical random spacing & timing, vertical random spacing; and suppression/smooth pursuit optokinetic videos: horizontal slow speed left & right, horizontal medium speed left & right, horizontal fast speed left & right, vertical slow speed up & down, vertical medium speed up & down, vertical fast speed up & down.

Different environments that can be used for the videos include cars: slow speed right, medium speed right, fast speed right; slow speed left, medium speed left, fast speed left, cars Suppression: slow speed right, medium speed right, fast speed right; slow speed left, medium speed left, fast speed left; fish: slow speed right, medium speed right, fast speed right, slow speed left, medium speed left, fast speed left; fish suppression/smooth pursuit: slow speed right, medium speed right, fast speed right; slow speed left, medium speed left, fast speed left, slow speed zig zag, medium speed zig zag, fast speed zig zag; snow: slow speed down, medium speed down, fast speed down, slow speed up, medium speed up, fast speed up; snow suppression/smooth pursuit: slow speed down, medium speed down, fast speed down; slow speed up, medium speed up, fast speed up; supermarket: slow speed forward, medium speed forward, fast speed forward, slow speed backward, medium speed backward, fast speed backward; and supermarket suppression: slow speed forward, medium speed forward, fast speed forward; slow speed backward, medium speed backward, fast speed backward.

### BRIEF DESCRIPTION OF THE DRAWINGS

The invention may be more readily understood by referring to the accompanying drawings in which:

FIG. 1 is a view of a patient seated on a static surface while wearing a virtual reality device in accordance with phase one of the present invention;

FIG. 2 is an example of a screen shot of a first phase one stimulation video;

FIG. 3 is an example of a screen shot of a first phase one suppression video;

FIG. 4 is an example of a screen shot of a second phase one stimulation video;

FIG. 5 is a view of a patient standing on a static surface while wearing the virtual reality device in accordance with phase two of the present invention;

FIG. 6 is an example of a screen shot of a first phase two stimulation video;

FIG. 7 is an example of a screen shot of a first phase two suppression video;

FIG. 8 is an example of a screen shot of a second phase two stimulation video;

FIG. 9 is a view of a patient jumping on a super dynamic surface while wearing the virtual reality device in accordance with phase three of the present invention;

FIG. 10 is an example of a screen shot of a first phase three stimulation video;

FIG. 11 is an example of a screen shot of a first phase three suppression video; and

FIG. 12 is an example of a screen shot of a second phase three stimulation video.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

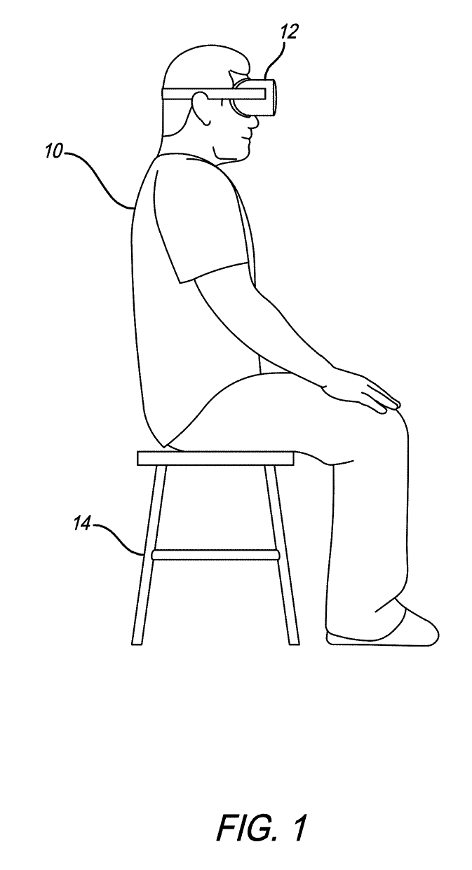

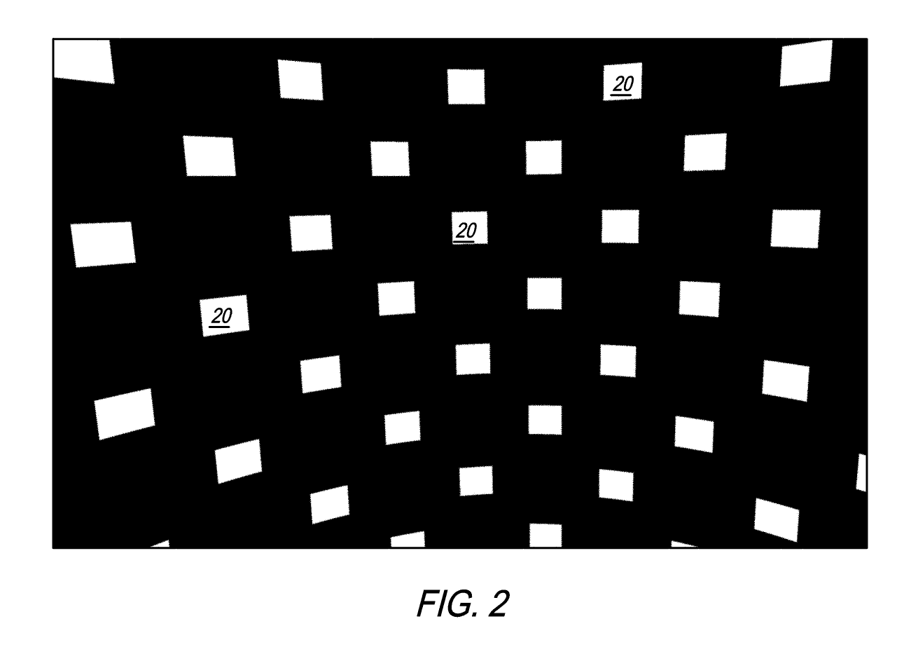

The present invention is a system and method for treating vestibular dysfunction. As discussed above, in a preferred embodiment, the present invention involves three phases of treatment. The figures depict an exemplary state of the patient during treatment in each phase (FIGS. 1, 5 and 9) and exemplary screenshots of videos used during the treatment (FIGS. 2-4, 6-8 and 10-12).

FIGS. 2-4, 6-8 and 10-12 are screen shots of exemplary stimulation and suppression videos that are loaded onto the virtual reality goggles 12. It will be appreciated that these are video/animation files that move in different directions (horizontal, vertical, diagonal) and at different speeds (fast, medium, slow). The videos are only exemplary and not intended to be limiting.

During all three phases of treatment, the videos are provided to first stimulate the patient's VOR (phase one), VSR (phase two) or otilith (phase three) system and then suppress the same system. Generally, the stimulation and suppression videos include three-dimensional objects that move at a speed. The stimulation videos include three-dimensional objects that move at a faster speed than the suppression video intended to be watched thereafter. In a preferred embodiment, the stimulation videos also include more three-dimensional objects or a higher density of three-dimensional objects than the suppression videos. Furthermore, subsequent stimulation videos include faster moving and/or higher density three-dimensional objects than previous stimulation videos viewed during the same phase of treatment.

FIGS. 1-4 relate to phase one of treatment. As shown in FIG. 1, in a preferred embodiment, the patient 10 is provided a virtual reality device 12 that is worn during treatment. In a preferred embodiment, the videos are all three-dimensional videos that are viewed on the virtual reality device 12. As shown in FIG. 1, during phase one of treatment the patient is preferably seated on a chair 14 or the like. At this phase of treatment it is preferable that the patient is in a static state when viewing the videos. In the static state, the patient is seated in a chair and watching the videos (may include phase one three-dimensional objects moving in the horizontal, vertical and diagonal directions at slow, medium and fast speeds dependent upon patient tolerance and level of central compensation).

Phase one of treatment is designed to hyper-stimulate the vestibular system in order to rehabilitate the VOR. Phase one is done to habituate and strengthen the VOR. At the beginning of treatment, while seated in a static state, the patient views a first phase one stimulation video on the virtual reality device 12 that is configured to stimulate the patient's vestibular ocular reflex. FIG. 2 shows a first phase one stimulation video that includes a first amount of phase one three-dimensional objects 20. The phase one-three dimensional objects 20 move in the video at a first speed. They can all move together or separately. In an exemplary embodiment, all of the phase one three-dimensional objects 20 move horizontally in the first phase one stimulation video. They also appear to be three-dimensional, as opposed to two-dimensional. In effect, they look like the reflections from a disco ball reflected onto a cylindrical wall.

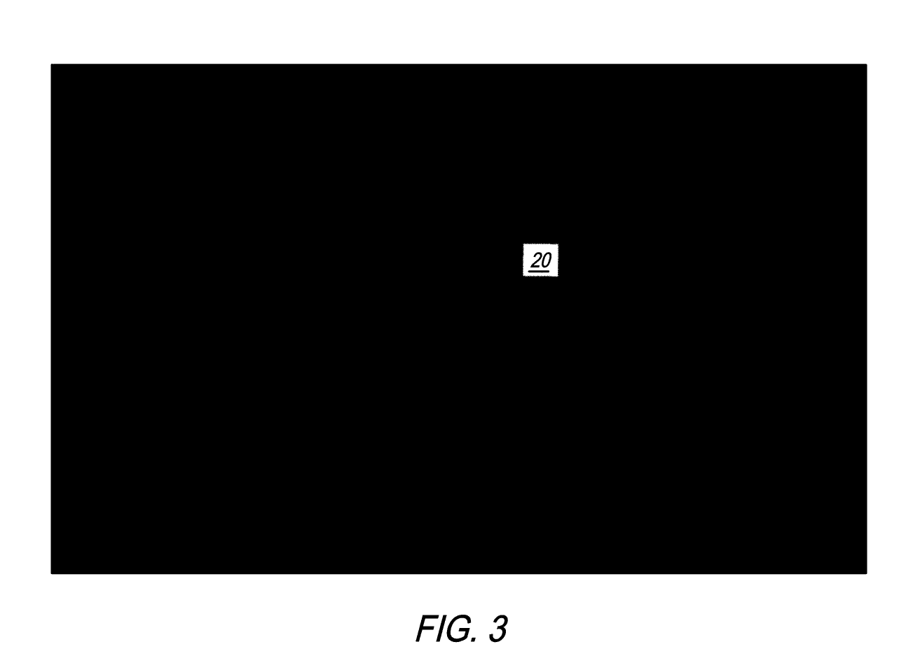

After viewing the first phase one stimulation video, the patient then views or plays a first phase one suppression video on the virtual reality device 12 that is configured to suppress the patient's vestibular ocular reflex. As shown in FIG. 3, the first phase one suppression video includes an amount of phase one three-dimensional objects 20 that is less than the first amount of phase one three-dimensional objects 20. Here, only a single phase one three-dimensional object 20 is included .

It will be appreciated, as discussed above, that for all phases of treatment, the videos can be viewed at a clinician's office or remote from the office, for example, at a patient's home. It will also be appreciated that it will depend on the amount of the patient's vestibular dysfunction and the patient's reaction to the videos on how many treatment sessions or videos the patient needs before moving on or graduating to the next phase of treatment. This is described in more detail above in the Summary of the Invention section.

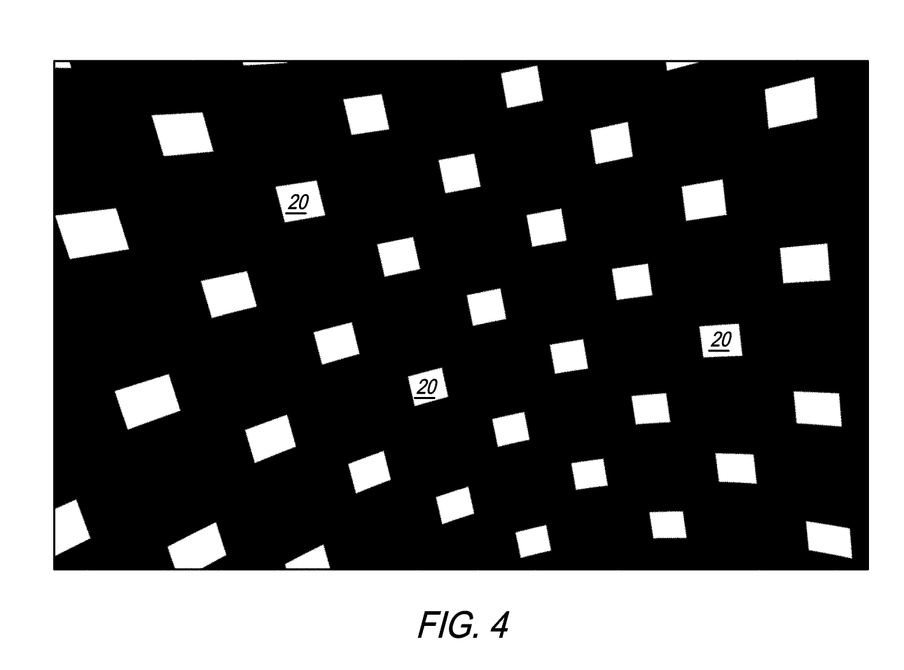

If the patient requires a second set of stimulation and suppression videos, either immediately after watching the first phase one suppression video, or at a later time, the patient then views a second phase one stimulation video on the virtual reality device 12. As shown in FIG. 4, the second phase one stimulation video includes a second amount of phase one three-dimensional objects 20. The second amount of phase one three-dimensional objects 20 can be greater than, the same as or less than the first amount. As shown in FIGS. 2 and 4, in a preferred embodiment, the first and second phase one three-dimensional videos include approximately the same amount of phase one three-dimensional objects 20. However, in the second phase one stimulation video the objects 20 move diagonally, as opposed to horizontally, which provides greater stimulation to the patient's VOR.

In another embodiment, the second amount of phase one three-dimensional objects 20 is greater than the first amount of phase one three-dimensional objects 20 and/or the second amount of phase one three-dimensional objects 20 are moving at a second speed that is greater than the first speed. The key is that the second phase one stimulation video provides greater stimulation than the first phase one stimulation video. A second phase one suppression video is then viewed by the patient. In all of the phases herein the second suppression videos (and all others beyond the second) are often the same as the first suppression video. In the suppression videos the three-dimensional objects may move at a slower speed than those in the previously viewed stimulation video. The suppression videos may also simply be a blank or black screen. In all phase one videos (stimulation or suppression), the objects can move horizontally, vertically, diagonally, randomized or a combination thereof

After the treating clinician determines that the patient's VOR has been adequately habituated and strengthened through diagnostic evaluation that evaluates and measures the patient's VOR function to be at a normative functional state compared to normative clinical data (meets functional criteria range of the normal subject population), the patient is moved on to phase two of the treatment process. If the clinician determines that the patient's VOR function has not been strengthened or habituated enough, the patient remains in phase one of treatment. This information can be found in as normative clinical data loaded by the manufacturer on specific diagnostic vestibular equipment, in industry-specific, research-based normative data studies or through a doctor's individual experience and history. The normative range of clinical data can be specific to diagnostic equipment and manufacturer. For example, normative range clinical data can come from the Videonystagmography (VNG) by balanceback (for the VOR phase), Computerized Dynamic Posturography by NeuroCom/Natus (for the VSR phase) and/or the Micromedical rotational chair. It will be appreciated that each patient will require a different amount of videos during phase one. For example, during phase one, a patient may view between 1 and 2000 videos.

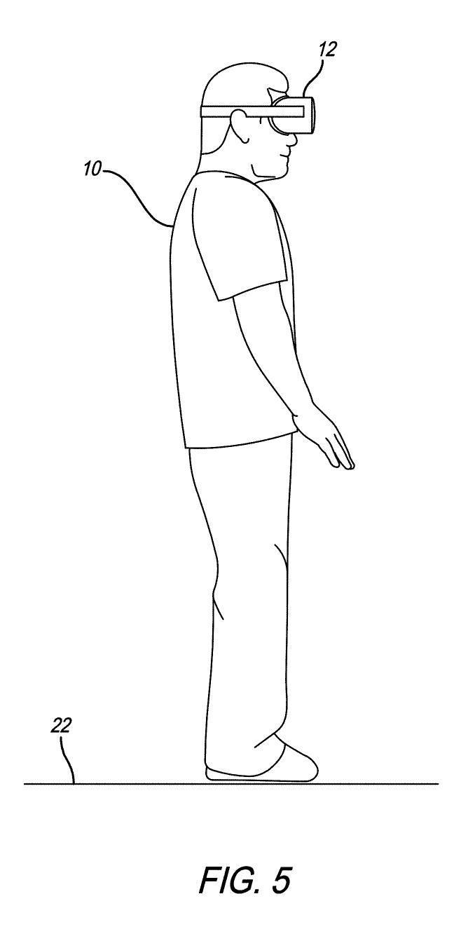

FIGS. 5-8 relate to phase two of treatment. As shown in FIG. 5, in a preferred embodiment, the patient 10 is once again provided the virtual reality device 12 that is worn during treatment (it may be the same or a different virtual reality device). In a preferred embodiment, the videos are all three-dimensional videos that are viewed on the virtual reality device 12. As shown in FIG. 5, during phase two of treatment the patient can be standing on a hard surface. The patient can also be standing on a slightly soft surface that has some give, such as a foam pad. At this phase of treatment it is preferable that the patient is in a dynamic state when viewing the videos. In the dynamic state, the patient can be standing on stable ground while watching the videos with head stable, standing on stable ground while watching videos with head movement, standing on thin firm foam while watching videos with head static, standing on thin firm foam while watching videos with head movement, standing on thick foam while watching videos with head static, standing on thick foam while watching videos with head movement, standing on wooden rocker board while watching videos with head movement, standing on wooden rocker board while watching videos with head static.

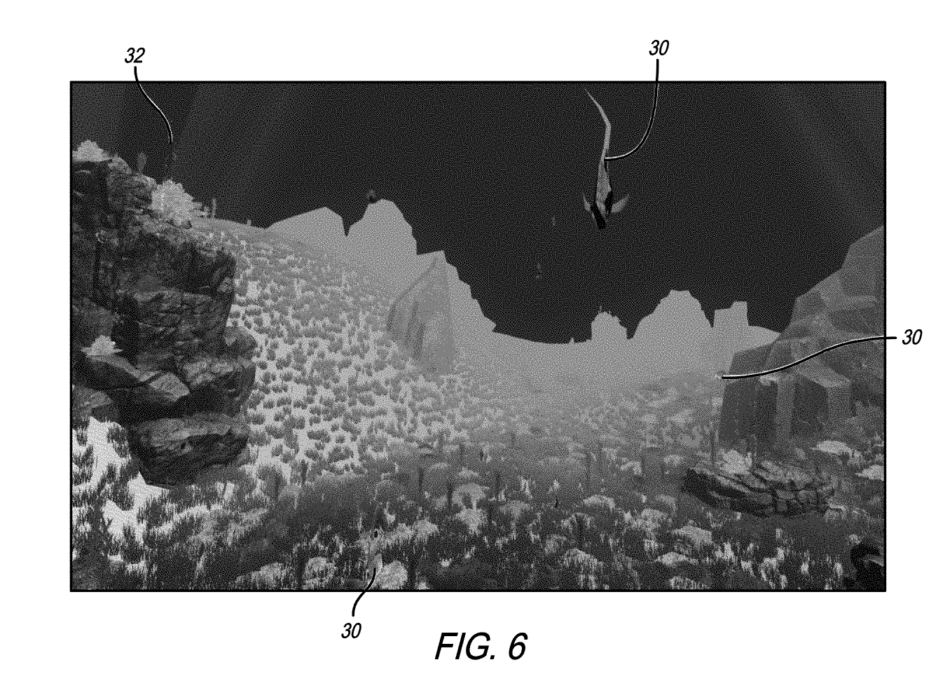

Phase two of treatment is designed to stimulate the patient's vestibulospinal reflex and integrate the vestibulospinal reflex and vestibular ocular reflex functions. At the beginning of treatment, while in a standing dynamic state, the patient views a first phase two stimulation video on the virtual reality device 12 that is configured to stimulate the patient's vestibulospinal reflex and integrate the vestibulospinal reflex and vestibular ocular reflex functions. FIG. 6 shows a first phase two stimulation video that includes a first amount of phase two three-dimensional objects. The phase two three-dimensional objects move in the video at a first speed. They can all move together or separately. There also can be more than one type of phase two three-dimensional objects. In an exemplary embodiment, the phase two three-dimensional objects include fish 30 and bubbles 32 moving in an underwater environment. The objects can all move together or separately. Furthermore, the objects can move at the same speed or at different speeds. Furthermore, the objects can move in the same direction or in different directions.

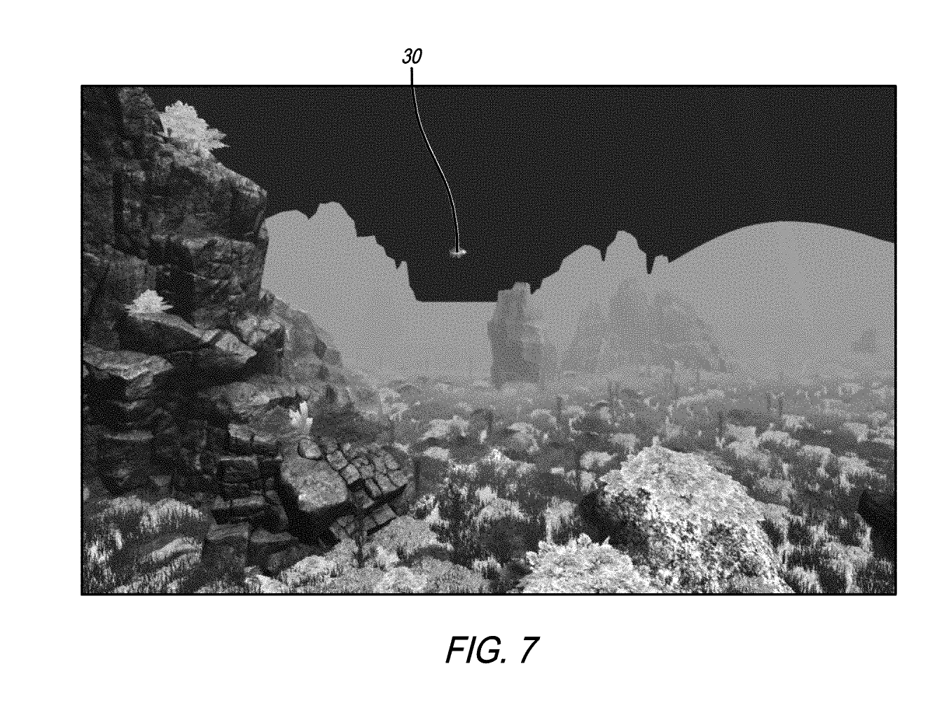

After viewing the first phase two stimulation video, the patient then views or plays a first phase two suppression video on the virtual reality device 12 that is configured to suppress the patient's vestibulospinal reflex and integrate the vestibulospinal reflex and vestibular ocular reflex functions. As shown in FIG. 7, the first phase two suppression video includes an amount of phase two three-dimensional objects that is less than the first amount of phase two three-dimensional objects. Here, only a single fish 30 and no bubbles 32 are included .

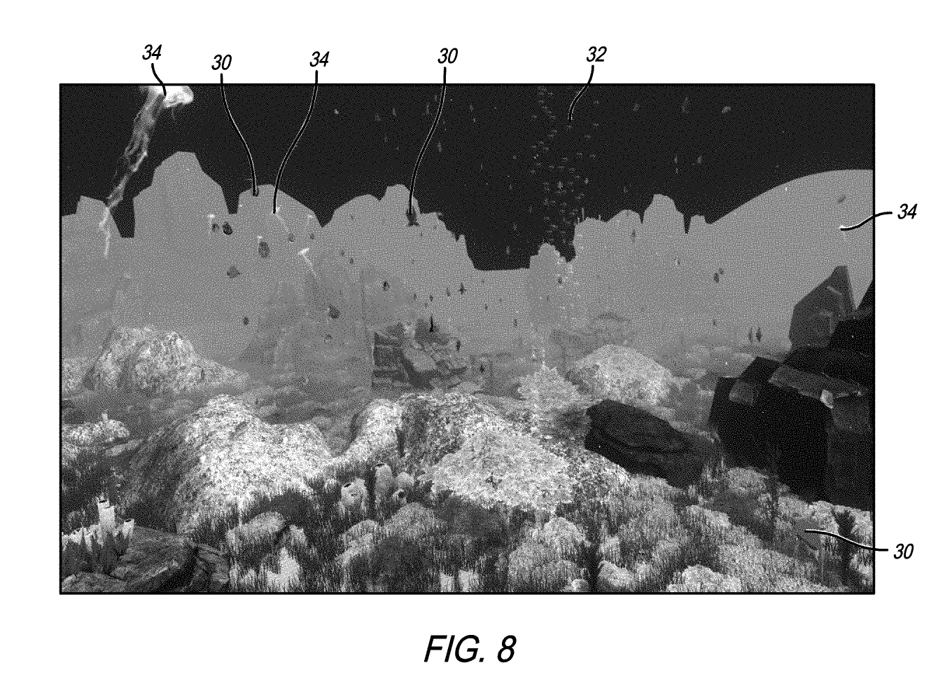

If the patient requires a second set of stimulation and suppression videos, either immediately after watching the first phase two suppression video, or at a later time, the patient then views a second phase two stimulation video on the virtual reality device 12. The second phase two stimulation video includes a second amount of phase two three-dimensional objects. The second amount of phase two three-dimensional objects can be greater than, the same as or less than the first amount. As shown in FIG. 8, in an exemplary embodiment, the second phase two three-dimensional video includes more fish 32 and bubbles 32 and has added jellyfish 34. In preferred embodiments, the second amount of phase two three-dimensional objects is greater than the first amount of phase two three-dimensional objects and/or the second amount of phase two three-dimensional objects are moving at a second speed that is greater than the first speed. The key is that the second phase two stimulation video provides greater stimulation than the first phase two stimulation video. A second phase two suppression video is then viewed by the patient.

In the phase two videos the videos can be changed to include increased speed and density options (this can be done from the administrative portal discussed below). Also, the videos can be altered so that the patient “moves through” the scene or be kept still and the scene moves around the patient. Suppression options include a stable environment with no stimuli that allows the clinician to instruct the patient to focus on stable targets in the environment as well as a function that shows one fish swimming side to side for several seconds at a time.

After the treating clinician determines that the patient's VSR has been adequately habituated and strengthened, the patient moves on to phase three of the treatment process. Once again, each patient will require a different amount of videos during phase two. For example, during phase two, a patient may view between 1 and 2000 videos.

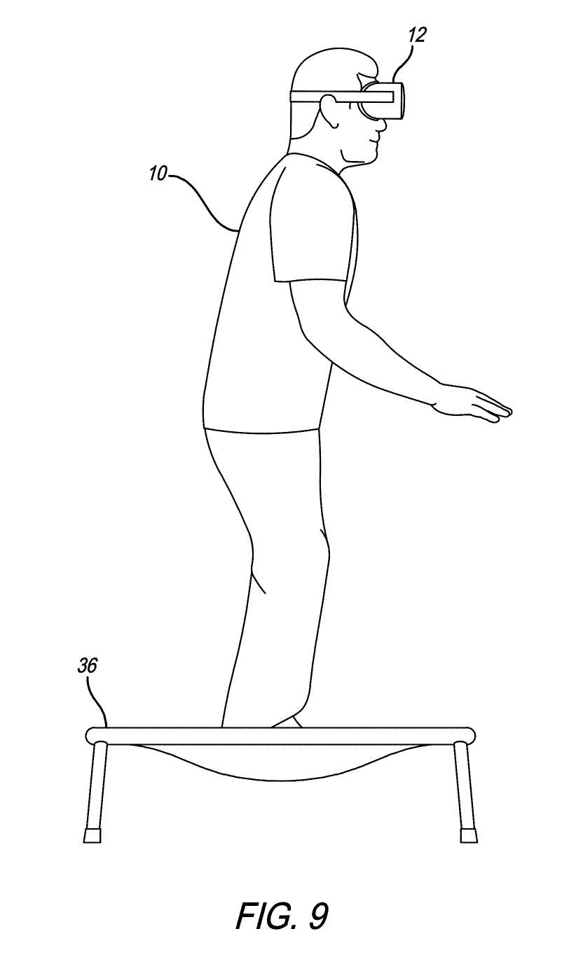

FIGS. 9-12 relate to phase three of treatment. As shown in FIG. 9, in a preferred embodiment, the patient 10 is once again provided the virtual reality device 12 that is worn during treatment (it may be the same or a different virtual reality device). In a preferred embodiment, the videos are all three-dimensional videos that are viewed on the virtual reality device 12. As shown in FIG. 9, in an exemplary embodiment, during phase three of treatment the patient is jumping on a trampoline. At this phase of treatment it is preferable that the patient is in a super dynamic state when viewing the videos. In the super dynamic state, the patient can be bouncing on pilates ball while watching the videos with head static, bouncing on pilates ball while watching the videos with head movement, bouncing on a trampoline while watching the videos with head static, bouncing on a trampoline while watching the videos with head movement. The patient can be seated or standing as long as they are in a super dynamic state of viewing the videos. In other examples, the patient can be seated on an exercise ball, standing or seated on foam, standing on a rocker board, a pilates ball or in a rotational chair. For example, see the chair taught in U.S. Pat. No. 7,559,766, the entirety of which is incorporated by reference herein.

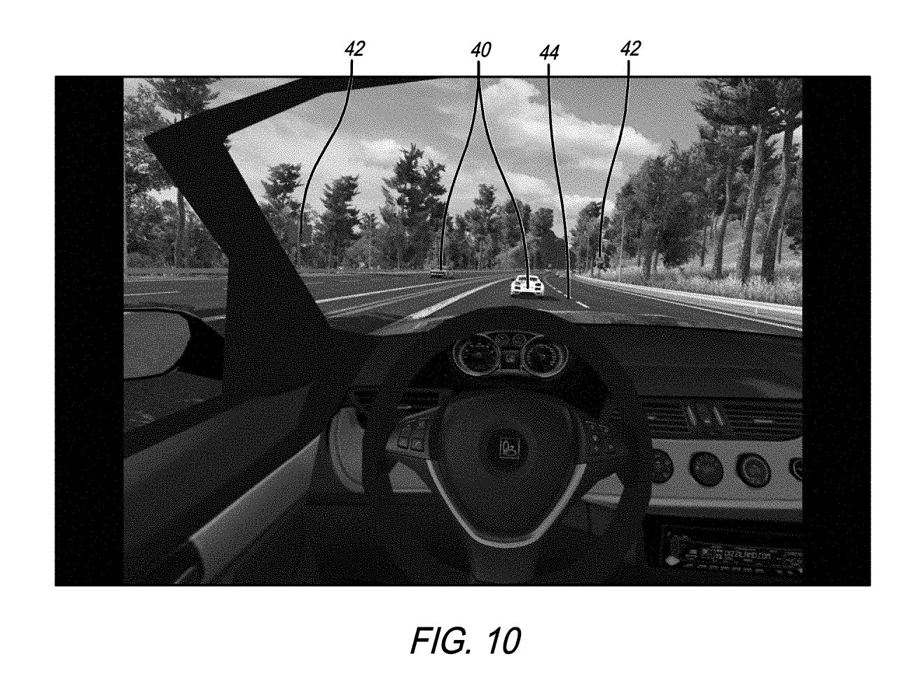

Phase three of treatment is designed to stimulate the patient's otolith dysfunction. At the beginning of treatment, while in a super dynamic state, the patient views a first phase three stimulation video on the virtual reality device 12. FIG. 10 shows a first phase three stimulation video that includes a first amount of phase three three-dimensional objects. The phase three three-dimensional objects move in the video at a first speed. They can all move together or separately. There also can be more than one type of phase three three-dimensional objects. In an exemplary embodiment, the phase three three-dimensional objects include cars 40, signs 42, road markings 44, trees, clouds, etc. The objects can all move together or separately. Furthermore, the objects can move at the same speed or at different speeds. Furthermore, the objects can move in the same direction or in different directions.

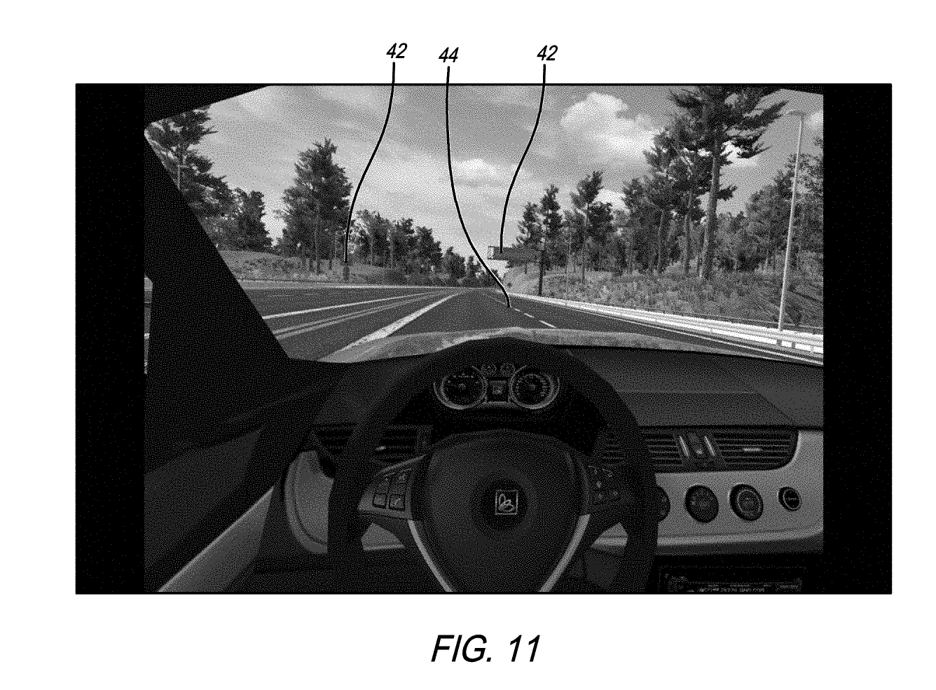

After viewing the first phase three stimulation video, the patient then views or plays a first phase three suppression video on the virtual reality device 12 that is configured to suppress the patient's system, and, in particular, the otolith dysfunction. As shown in FIG. 11, the first phase three suppression video includes an amount of phase three three-dimensional objects that is less than the first amount of phase three three-dimensional objects. Here, only signs 42 and road markings 44 are present and the cars 40 are omitted.

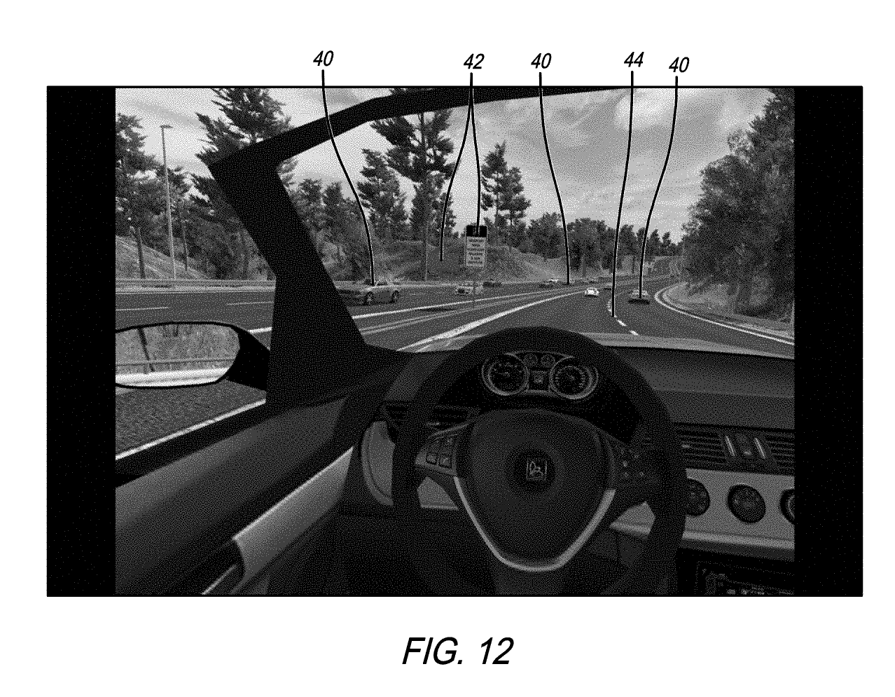

If the patient requires a second set of stimulation and suppression videos, either immediately after watching the first phase three suppression video, or at a later time, the patient then views a second phase three stimulation video on the virtual reality device 12. The second phase three stimulation video includes a second amount of phase two three-dimensional objects. The second amount of phase two three-dimensional objects can be greater than, the same as or less than the first amount. As shown in FIG. 12, in an exemplary embodiment, the second phase three three-dimensional video includes more cars 40. In preferred embodiments, the second amount of phase three three-dimensional objects is greater than the first amount of phase three three-dimensional objects and/or the second amount of phase three three-dimensional objects are moving at a second speed that is greater than the first speed. The key is that the second phase three stimulation video provides greater stimulation than the first phase three stimulation video. A second phase three suppression video is then viewed by the patient.

In the phase three videos the videos can be changed to include increased speed and density options (which may once again be done from the administrative portal). Also, the videos can allow perspective options that changes the patient from the driver's seat of the car to the side of the road watching the cars pass. Suppression options include a stable environment with no stimuli that allows the clinician to instruct the patient to focus on stable targets in the environment. Other scenes for videos can include a winter/snowing scenes or a grocery store aisle scene.

After the treating clinician determines that the patient's otolith dysfunction has been adequately habituated and strengthened, the treatment may be stopped. Once again, each patient will require a different amount of videos during phase three. For example, during phase three, a patient may view between 1 and 2000 videos.

It will be appreciated that the present invention also includes a computer, tablet or mobile phone program or application (“app”) that can be accessed by both the treating clinician and the patient. This includes an administrative portal where the clinician can upload new videos for the patient to access. The patient's progress can be tracked. The patient cannot view videos in the next phase of treatment until the clinician has assessed the patient and determined that they can move forward.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used. Further, any specific materials noted herein are only examples: alternative implementations may employ differing materials.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A method for the treatment of vestibular dysfunction, the method comprising the steps of:
(a) providing a virtual reality device to be worn by a patient,
(b) playing a first phase one stimulation video on the virtual reality device that is configured to stimulate the patient's vestibular ocular reflex, wherein the first phase one stimulation video includes a first amount of phase one three-dimensional objects,
(c) playing a first phase one suppression video on the virtual reality device that is configured to suppress the patient's vestibular ocular reflex, wherein the first phase one suppression video includes an amount of phase one three-dimensional objects that is less than the first amount of phase one three-dimensional objects,
(d) playing a first phase two stimulation video on the virtual reality device that is configured to stimulate the patient's vestibulospinal reflex and integrate the vestibulospinal reflex and vestibular ocular reflex functions, wherein the first phase two stimulation video includes a first amount of phase two three-dimensional objects,
(e) playing a first phase two suppression video on the virtual reality device that is configured to suppress the patient's vestibulospinal reflex and integrate the vestibulospinal reflex and vestibular ocular reflex functions, wherein the first phase two suppression video includes an amount of phase two three-dimensional objects that is less than the first amount of phase two three-dimensional objects,
(f) playing a first phase three stimulation video on the virtual reality device that is configured to stimulate the patient's otolith dysfunction, wherein the first phase three stimulation video includes a first amount of phase three three-dimensional objects, and
(g) playing a first phase three suppression video on the virtual reality device that is configured to suppress the patient's system, wherein the first phase three suppression video includes an amount of phase three three-dimensional objects that is less than the first amount of phase three three-dimensional objects.

2. The method of claim 1 wherein steps (b) and (c) are performed while the patient is in a static state.

3. The method of claim 2 wherein steps (d) and (e) are performed while the patient is in a dynamic state.

4. The method of claim 3 wherein steps (0 and (g) are performed while the patient is in a super dynamic state.

5. The method of claim 1 further comprising, after step (c), playing a second phase one stimulation video on the virtual reality device, wherein the second phase one stimulation video includes a second amount of phase one three-dimensional objects, wherein the second amount of phase one three-dimensional objects is greater than the first amount of phase one three-dimensional objects.

6. The method of claim 1 comprising, after step (c), playing a second phase one stimulation video on the virtual reality device, wherein the second phase one stimulation video includes an amount of phase one three-dimensional objects, wherein at least one of the phase one three-dimensional objects in the first phase one stimulation video moves at a first speed, wherein at least one of the phase one three-dimensional objects in the second phase one stimulation video moves at a second speed, wherein the second speed is greater than the first speed.

7. The method of claim 1 comprising, after step (c), playing a second phase one stimulation video on the virtual reality device, wherein the second phase one stimulation video includes an amount of phase one three-dimensional objects, wherein each of the phase one three-dimensional objects in the second phase one stimulation video move in a different direction than each of the phase one three-dimensional objects in the first phase one stimulation video.

8. The method of claim 1 wherein at least one of the three-dimensional objects in the first phase one suppression video moves at a slower speed than at least one of the three-dimensional objects in the first phase one stimulation video.

9. The method of claim 5 wherein the first phase one stimulation video is played at a treatment advisor's office, and wherein the second phase one stimulation video is played at a location remote from the treatment advisor's office.

10. The method of claim 1 wherein after step (c), the method further comprises the step of assessing the patient to determine if they can proceed to step (d).

11. The method of claim 1 wherein after either of steps (c) or (e), the method further comprises the step of assessing the patient to determine if they can proceed to the next step.

12. A method for the treatment of vestibular dysfunction, the method comprising the steps of:
(a) providing a virtual reality device to be worn by a patient,
(b) beginning phase one of treatment,
(c) playing a first phase one stimulation video on the virtual reality device that is configured to stimulate the patient's vestibular ocular reflex, wherein the first phase one stimulation video includes a first amount of phase one three-dimensional objects,
(d) playing a first phase one suppression video on the virtual reality device that is configured to suppress the patient's vestibular ocular reflex, wherein the first phase one suppression video includes an amount of phase one three-dimensional objects that is less than the first amount of phase one three-dimensional objects, wherein steps (c) and (d) are performed while the patient is in a static state,
(e) comparing the patient's vestibular ocular reflex to a range of vestibular ocular reflex normative data, wherein when the patient's vestibular ocular reflex is within the range of vestibular ocular reflex normative data the patient moves to phase two,
(f) beginning phase two of treatment,
(g) playing a first phase two stimulation video on the virtual reality device that is configured to stimulate the patient's vestibulospinal reflex and integrate the vestibulospinal reflex and vestibular ocular reflex functions, wherein the first phase two stimulation video includes a first amount of phase two three-dimensional objects,
(h) playing a first phase two suppression video on the virtual reality device that is configured to suppress the patient's vestibulospinal reflex and integrate the vestibulospinal reflex and vestibular ocular reflex functions, wherein the first phase two suppression video includes an amount of phase two three-dimensional objects that is less than the first amount of phase two three-dimensional objects, wherein steps (g) and (h) are performed while the patient is in a dynamic state,
(i) comparing the patient's vestibulospinal reflex to a range of vestibulospinal reflex normative data, wherein when the patient's vestibulospinal reflex is within the range of vestibulospinal reflex normative data the patient moves to phase three,
(j) beginning phase three of treatment,
(k) playing a first phase three stimulation video on the virtual reality device that is configured to stimulate the patient's otolith dysfunction, wherein the first phase three stimulation video includes a first amount of phase three three-dimensional objects, and
(l) playing a first phase three suppression video on the virtual reality device that is configured to suppress the patient's otolith dysfunction, wherein the first phase three suppression video includes an amount of phase three three-dimensional objects that is less than the first amount of phase three three-dimensional objects, wherein steps (k) and (l) are performed while the patient is in a super dynamic state.

13. The method of claim 12 further comprising the step of comparing the patient's otolith function to a range of otolith function normative data, wherein when the patient's otolith function is within the range of otolith function normative data the patient finishes treatment.
